(19) United States
(12) Patent Application Publication
(10) Pub. No.: US 2013/0044237 A1
(43) Pub. Date: Feb. 21, 2013

(54) High Dynamic Range Video

(71) Applicants: Ike Ikizyan, Newport Coast, CA (US); Marcus Kellerman, Poway, CA (US)

(72) Inventors: Ike Ikizyan, Newport Coast, CA (US); Marcus Kellerman, Poway, CA (US)

(73) Assignee: BROADCOM CORPORATION, Irvine, CA (US)

(21) Appl. No.: 13/209,743

(22) Filed: Aug. 15, 2011

(51) Int. Cl. H04N 5/235; H04N 9/74

(52) U.S. Cl. 348/229.1; 348/584; 348/E09.055

(57) ABSTRACT

Disclosed are various embodiments of high dynamic range (HDR) video. In one embodiment a method includes obtaining first and second frames of a series of digital video frames, where the first and second frames have different exposure levels. The second frame is reregistered with respect to the first frame based at least in part upon motion estimation, where the motion estimation accounts for the different exposure levels of the first and second frames, and the first frame is combined with the reregistered second frame to generate an HDR frame. In another embodiment, a video device includes means for attenuating the exposure of a video frame captured by an image capture device and an HDR converter configured to combine a plurality of digital video frames to generate an HDR frame, where each digital video frame combined to generate the HDR frame has a different exposure level.

### BACKGROUND

Devices for taking digital videos are widely available and used by both professionals and amateurs alike. Digital video capabilities have also been incorporated into mobile phones. However, because a wide range of intensity levels are commonly present, details visible to the human eye can be lost in the digital video images.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a graphical representation of a video device in accordance with various embodiments of the present disclosure.

FIG. 2 is a graphical representation of an example of exposure level variation in the video device of FIG. 1 in accordance with various embodiments of the present disclosure.

FIG. 3 illustrates examples of exposure level variation in a series of digital video frames captured by the video device of FIG. 1 in accordance with various embodiments of the present disclosure.

FIGS. 4 and 5 are graphical representations of examples of high dynamic range (HDR) converters of the video device of FIG. 1 in accordance with various embodiments of the present disclosure.

FIG. 6 is a flowchart illustrating an example of HDR frame generation implemented by an HDR converter of the video device of FIG. 1 in accordance with various embodiments of the present disclosure.

### DETAILED DESCRIPTION

Real world luminance dynamic ranges far exceed what can be represented by typical video devices. The digital resolution capabilities of the digital video device often prevent finer details and variations from being captured in a digital image when a wide range of illumination is present. Simple contrast reduction using multiple images of the same scene taken at different exposure levels can reduce the contrast, but local detail is sacrificed in the process. High dynamic range (HDR) techniques attempt to compress the range in a way that preserves the local details. Using video frames with different exposures and adjusting for the motion of objects between frames allows for the generation of HDR video frames. By taking into account the different attenuation levels of the frames, it is possible to use motion estimation and motion compensation to correlate objects between the frames.

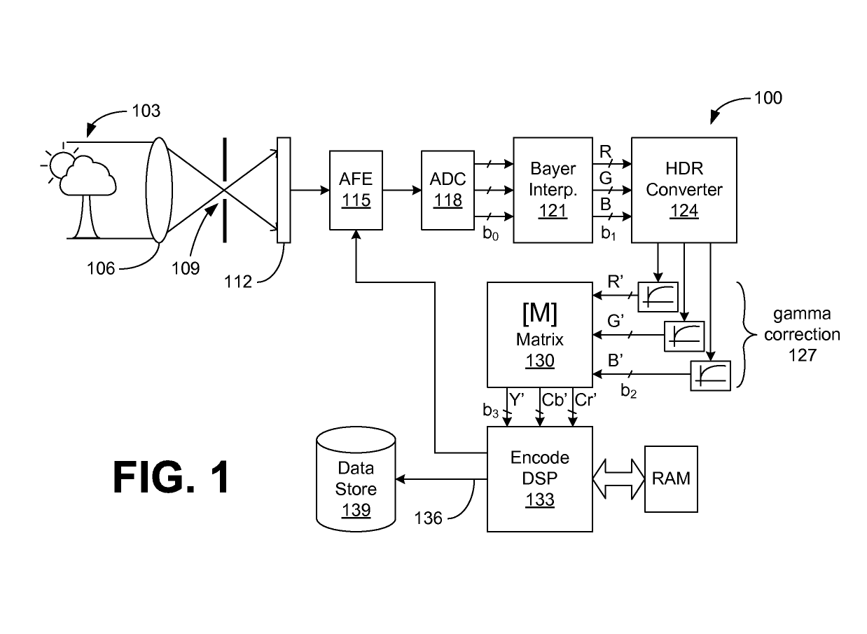

With reference to FIG. 1, shown is a graphical representation of a video device 100 such as, but not limited to, a mobile phone, personal digital assistant (PDA), laptop computer, electronic tablet, or other electronic device. The video device 100 includes means for capturing a series of digital video frames of a scene, event, or other activity 103. The video device 100 includes a lens 106, an aperture 109, and an image capture device 112 such as, e.g., a complementary metal oxide semiconductor (CMOS) or charge coupled device (CCD) Bayer array sensor. The lens 106 focuses light from the scene, event, or activity 103 through the aperture 109 onto the image capture device 112. An analog front end (AFE) 115 conditions the captured image signal before being digitized by an analog-to-digital converter (ADC) 118.

The series (or sequence) of digital video frames is captured at a plurality of exposure levels. The exposure level of the frames may be varied in multiple ways. In one embodiment, ISO of the video device 100 may be controlled such that adjacent frames are captured at different exposures. Typically, the ISO controls the gain of the AFE 115. It should be noted that adjusting the ISO can also have an impact on the signal to noise ratio (SNR) of the captured frame. In another embodiment, the aperture 109 may be varied between frame captures such that adjacent frames are obtained at different exposure levels. Varying the aperture 109 between frames can also generate differences in depth of field between the digital video frames. In other embodiments, the shutter speed of the video device 100 may be varied between frame captures. Using different shutter speeds can result in different levels of motion blur between the digital video frames.

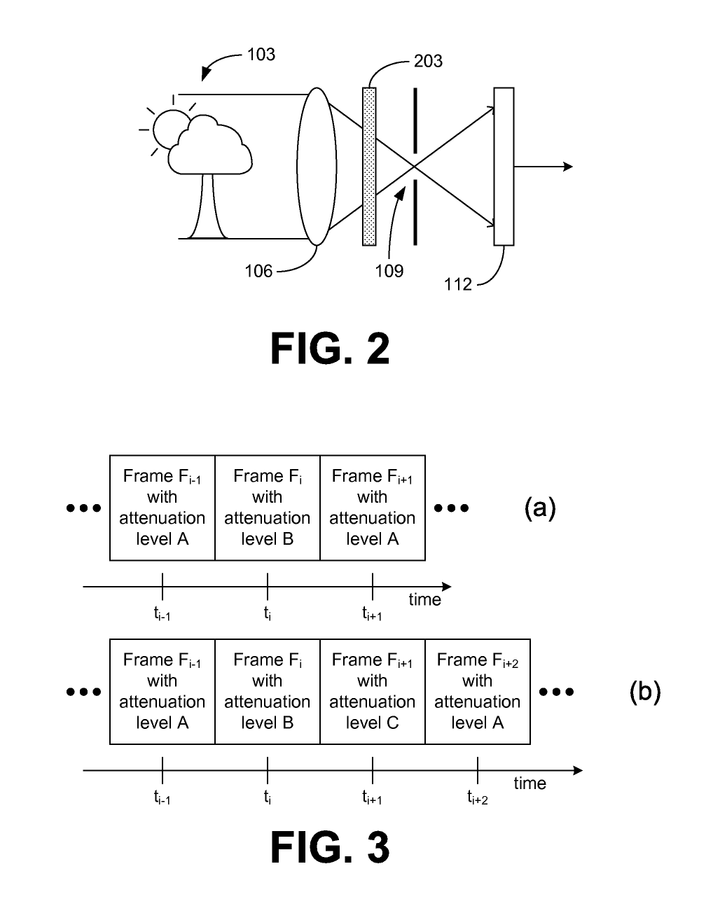

In some embodiments, an optical attenuator may be used to control the exposure of each captured video frame. Referring now to FIG. 2, shown is an alternative embodiment including an optical attenuator 203 for varying the exposure levels of the digital video frames captured by the video device 100 of FIG. 1. In the example of FIG. 2, the optical attenuator 203 is positioned between the lens 106 and the aperture 109. The optical attenuator 203 may include, e.g., a liquid crystal (LC) light attenuation layer that may be controlled to vary the exposure of the image capture device 112. The LC attenuator can be controlled electronically to reduce the strength of light entering the video device 100 without the use of moving parts. In addition, the LC attenuator can be made very thin allowing for very small form factors such as those found in cell phone cameras. The benefit of using an optical attenuator 203 is that it allows the aperture and shutter speed remain consistent between varying exposures. This maintains depth of field and motion blur between adjacent frames.

Referring back to FIG. 1, the digitized signal from the ADC 118 is in the linear light domain which is non-linear with respect to human visual perception. Since RGB subpixels are not co-sited, a Bayer interpolation 121 is applied to the digital information to produce an RGB value for each output pixel. A high dynamic range (HDR) converter 124 converts the series of digital video frames provided by the Bayer interpolation 121 into a series of HDR video frames as will be discussed in more detail below. A gamma correction 127 provides a nonlinear mapping to produce perceptually linear values denoted as R′G′B′, which may then be converted to Y′Cb′Cr′ using matrix multiplication 130. These values may then be sub-sampled, e.g., to 8-bit 4:2:0 Y′Cb′Cr′ and encoded into an elementary stream using an encode digital signal processor (DSP) 133. The encoding may be MPEG, AVC, or other encoding as appropriate.

The resulting bitstream 136 may then be multiplexed with audio information for rendering and/or saved to a data store 139 such as, e.g., random access memory (RAM), read-only memory (ROM), hard disk drives, solid-state drives, USB flash drives, memory cards accessed via a memory card reader, optical discs accessed via an optical disc drive, and/or other memory components, or a combination of any two or more of these memory components for subsequent retrieval or transfer.

The HDR converter 124 combines a plurality of frames from the series of digital video frames, where each of the combined frames has a different exposure level, to generate an HDR video frame. By repeating the combination of digital video frames, a series of HDR video frames may be generated. A plurality of predefined attenuation levels may be used to provide the various exposure levels. Referring to FIG. 3, shown are graphical representations illustrating examples of the exposure levels of the digital video frames with respect to time. For example, if two frames are used to generate the HDR frame, the exposures may alternate between two levels of attenuation. FIG. 3(a) depicts an example of obtaining a series of video frames with two attenuation levels A and B (e.g., attenuation level A may be no attenuation and attenuation level B may be about 50% attenuation). Two adjacent frames do not have the same exposure level and, thus, can be used to generate the HDR frame. Additional frames may also be used to generate the HDR frame. FIG. 3(b) depicts an example of obtaining a series of video frames with three attenuation levels A, B, and C (e.g., no attenuation, about 30% attenuation, and about 60% attenuation). Thus, any three adjacent frames have different exposure levels and may be used to generate an HDR frame. The exposure pattern may be expanded to include additional attenuation levels (e.g., four or more) as can be understood.

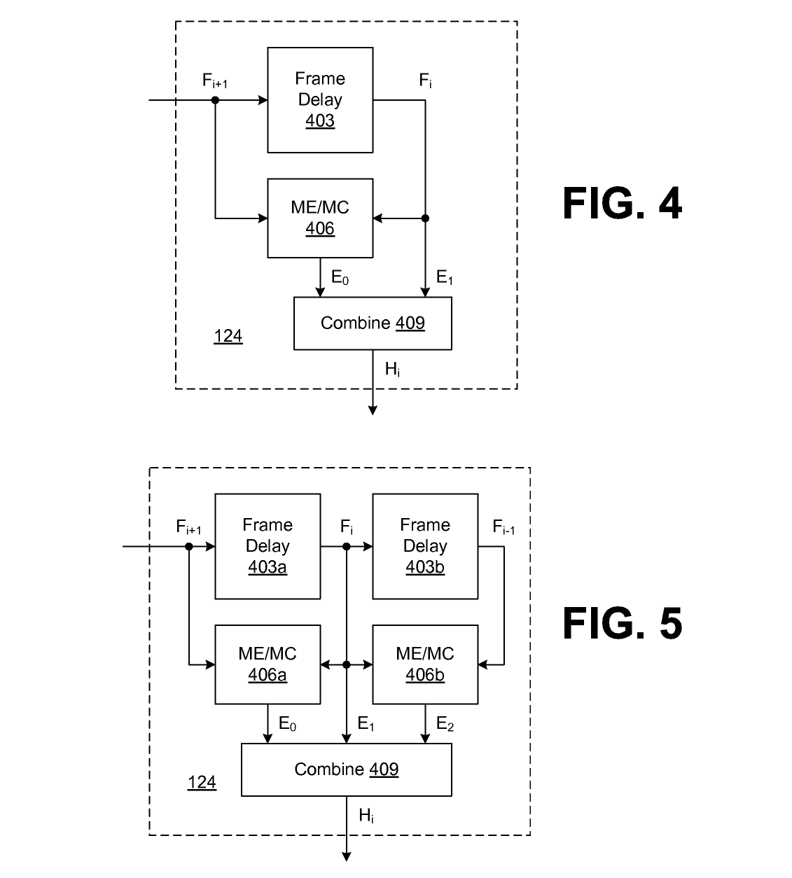

The HDR converter 124 may combine two or more adjacent frames from the series to generate the HDR frame. Referring now to FIG. 4, shown is one embodiment, among others, of the HDR converter 124. In the embodiment of FIG. 4, two adjacent frames (Fᵢ and Fᵢ₊₁) are combined to produce the HDR frame (Hᵢ). A first digital video frame (Fᵢ) at a first exposure level (e.g., B of FIG. 3(a)) is obtained by the HDR converter 124 and delayed for one time period by a frame delay 403 until the next adjacent digital frame (Fᵢ₊₁) at a second exposure level (e.g., A of FIG. 3(a)) is obtained by the HDR converter 124. In order to combine the two frames (Fᵢ and Fᵢ₊₁), objects that moved between the frame acquisitions are aligned (or reregistered) using techniques of motion estimation (ME) and motion compensation (MC) 406. However, because the frames are at different exposure levels, the ME/MC 406 is modified to account for the discrepancies produced by the different attenuation levels. The optimal matching between objects in adjacent video frames may be determined using the methods such as, e.g., the sum of absolute differences (SAD) which compare the absolute values of the pixels.

Typically, block matching algorithms used in frame interpolation assume corresponding blocks or objects have similar pixel values. However, because the digital video frames are captured at different exposure levels, corresponding pixel values are not the same because of the different attenuation levels. By taking into account the different exposure levels of the frames, it is possible to align blocks or objects of the two frames. Because the predefined attenuation levels are known, the relationship may be used to account for the exposure differences. For example, if it is known that the second attenuation level is twice the first attenuation level, then the pixel values of the attenuated frames may be adjusted by a factor of two for comparison. Since the exposure shifts produce monotonic mappings to the pixel values, the rank of the pixels within a block should remain consistent. This allows for rank-based relative comparisons to be utilized.

In the embodiment of FIG. 4, the first video frame (Fᵢ) is used as a reference frame. The second video frame (Fᵢ₊₁) is reregistered with respect to the first frame (Fᵢ) using ME/MC 406. The two images at different exposures (E₀ and E₁) are then combined 409 to generate an HDR video frame (Hᵢ) using, e.g., tone mapping or other appropriate contrast enhancement process. An example of tone mapping is to remove texture detail from the image and perform compression using an appropriate mapping (e.g., S-curve mapping) and then adding the texture detail back in. In this way, local detail (or texture) is maintained while the overall dynamic range is reduced to match the capabilities of the display. Nonlinear filtering is applied to segregate the texture details from the base, or illumination, layer of the image. The base layer is subjected to compression to map the large dynamic range down to a practical range while the details or texture layer undergoes only subtle changes. The two resulting layers are then combined to produce an HDR frame (RGB image) that follows the remaining path illustrated in FIG. 1.

In some implementations, the HDR video frames are generated at a fraction of the rate at which the digital video frames are being captured. For example, the HDR converter 124 obtains two adjacent video frames (e.g., captured at time tᵢ and tᵢ₊₁) to generate an HDR video frame. The HDR converter 124 then obtains two new adjacent video frames (e.g., captured at time tᵢ₊₂ and tᵢ₊₃) to generate the next HDR frame. In this way, the HDR frame rate is half the capture rate of the digital video frames. In other implementations, the HDR video frames are generated at the same rate as the digital video frames are being captured. In this case, each digital video frame is utilized twice to generate two different HDR frames. Thus, first and second adjacent video frames (e.g., captured at time t and tᵢ₊₁) are used to generate an HDR frame. The HDR converter 124 then obtains the next adjacent video frame (e.g., captured at time tᵢ₊₂) to generate the next HDR frame from the second and third video frames (e.g., captured at time tᵢ₊₁ and tᵢ₊₂).

Additional exposure levels may be used to generate the HDR video frames. Referring to FIG. 5, shown is another embodiment of the HDR converter 124, where three adjacent frames (Fᵢ₊₁, Fᵢ, and Fᵢ₋₁) are combined to produce the HDR frame (Hᵢ). In the example of FIG. 5, digital video frame (Fᵢ₋₁) at a first exposure level (e.g., A of FIG. 3(b)) is obtained by the HDR converter 124 and delayed for two time periods by frame delays 403a and 403b and digital video frame (Fᵢ) at a second exposure level (e.g., B of FIG. 3(b)) is obtained by the HDR converter 124 and delayed for one time period by frame delay 403a until the next adjacent digital frame (Fᵢ₊₁) at a third exposure level (e.g., C of FIG. 3(b)) is obtained by the HDR converter 124. In the embodiment of FIG. 5, outer video frames (Fᵢ₊₁ and Fᵢ₋₁) are reregistered with respect to the middle frame (Fᵢ) using ME/MC 406a and 406b, respectively. In other embodiments, the first two adjacent frames may be reregistered to the last video frame or the last two adjacent frames may be reregistered to the first video frame. The three images at different exposures (E₀, E₁, and E₂) are then combined 409 to generate an HDR video frame (Hᵢ) using, e.g., tone mapping or other appropriate contrast enhancement process. As discussed above, by shifting in single frame increments, the HDR video frames may be generated at the same rate as the digital video frames are being captured. In other implementations, the HDR video frames are generated at a fraction of the rate at which the digital video frames are being captured by shifting in multiple frame increments.

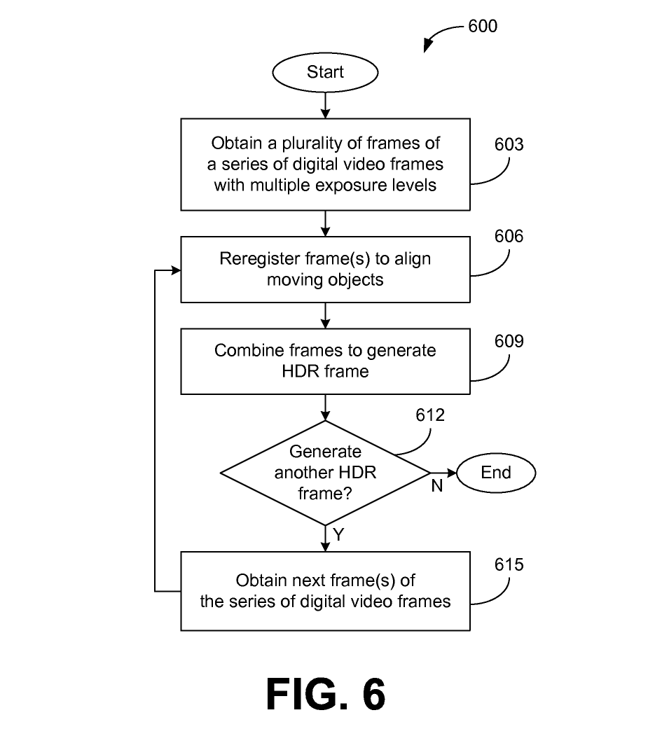

Referring next to FIG. 6, shown is a flowchart illustrating an example of HDR frame generation in accordance with various embodiments of the present disclosure. Beginning with block 603, a plurality of frames having different exposure levels are obtained from a series of digital video frames. For example, a first frame having a first exposure level and a second frame having a second exposure level are obtained. The first and second frames may be adjacent frames in the series of digital video frames such as, e.g., frames Fᵢ₋₁ and Fᵢ in FIGS. 3(a) and 3(b) or they may not be adjacent frames such as, e.g., frames Fᵢ₋₁ and Fᵢ₊₁ in FIG. 3(b). The use of adjacent frames allows for generation of HDR frames at the same rate as the capture rate of the series of digital video frames. If nonadjacent frames are obtained, then the HDR frames may be generated at a rate less than the capture rate of the series of digital video frames.

In some implementations, a third frame having a third exposure level different than the first and second exposure levels is obtained. The first, second, and third frames may be a sequence of adjacent frames such as, e.g., frames Fᵢ₋₁, and Fᵢ, and Fᵢ₊₁ in FIG. 3(b) or may not be adjacent frames in the series of digital video frames. In other implementations, additional frames having different exposure levels may be obtained. The different exposure levels may be obtained by, e.g., varying the ISO, aperture, shutter speed, and/or combinations thereof for each digital video frame. In other embodiments, an optical attenuator such as, but not limited to, a liquid crystal (LC) light attenuation panel may be used to vary the exposure of the captured digital video frames as described above. As illustrated in FIG. 3, a pattern of different predefined exposure levels is repeated in the series of digital video frames.

In block 606, one or more of the obtained frames are reregistered with respect to one of the obtained frames to align objects and/or blocks of pixels that have moved between frame captures. As discussed above, motion estimation (ME) and motion compensation (MC) can account for the difference in exposure levels between the captured digital video frames during the frame interpolation. Because the attenuation levels producing the different exposure levels are known, the relationship may be used to account for the exposure differences between frames.

If the first and second frames were obtained in block 603, the first frame may be reregistered with respect to the second frame or the second frame may be reregistered with respect to the first frame using ME/MC for frame interpolation and taking into account the differences between the exposure levels. If first, second and third frames were obtained in block 603, the first and third frames may be reregistered with respect to the second frame. In alternative implementations, the first and second frames may be reregistered with respect to the third frame or the second and third frames may be reregistered with respect to the first frame. By reregistering to adjacent frames in the series of digital video frames, the movement of objects between the frames is minimized which can reduce the processing requirements.

The reregistered frames are combined with the referenced frame to generate an HDR frame in block 609. For instance, if the second frame is reregistered with respect to the first frame, then the first frame is combined with the reregistered second frame to generate the HDR frame using, e.g., tone mapping as discussed above. If the second and third frames were reregistered with respect to the first frame, then the first frame is combined with the reregistered second frame and the reregistered third frame to generate the HDR frame.

It is then determined in block 612 if another HDR frame needs to be generated, e.g., to produce a series of HDR video frames. If not, then the flowchart ends. If another HDR frame is to be generated in block 612, then the one or more additional frame(s) are obtained in block 615. The HDR frames may be generated from overlapping or separate groups of digital video frames having the same pattern of exposure levels. For example, if only first and second frames were obtained in block 603, a third frame in the series of digital video frames that has the first exposure level may be obtained in block 615. The third frame may be adjacent to the second frame in the series of digital video frames. The third frame may then be reregistered with respect to the second frame in block 606 and the reregistered third frame may be combined with the second frame in block 609 to generate a second HDR frame from an overlapping group of digital video frames.

In other implementations, a third frame having the first exposure level and a fourth frame having the second exposure level may be obtained in block 615. The fourth frame may then be reregistered with respect to the third frame in block 606 and the reregistered fourth frame may be combined with the third frame in block 609 to generate a second HDR frame from a separate group of digital video frames. In either case, the second HDR frame may be adjacent to the first previously generated HDR frame in a series of HDR video frames. This may be applied to larger groups of digital video frames as can be understood.

In block 612, it is again determined if another HDR frame should be generated. It so, the sequence of obtaining the next frame(s) in block 615, reregistering frames in block 606, and combining frames to generate an HDR frame in block 609 continues until another HDR frame in not needed. At that point, the flowchart ends.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method, comprising:
obtaining a first frame of a series of digital video frames, the first frame having a first exposure level;
obtaining a second frame from the series of digital video frames, the second frame having a second exposure level different than the first exposure level;
reregistering the second frame with respect to the first frame based at least in part upon motion estimation, where the motion estimation accounts for the different exposure levels; and
combining the first frame with the reregistered second frame to generate a high dynamic range (HDR) frame.

2. The method of claim 1, wherein the first and second frames are adjacent frames in the series of digital video frames.

3. The method of claim 1, wherein the first and second exposure are different predefined levels.

4. The method of claim 1, further comprising:
obtaining a third frame from the series of digital video frames, the third frame having the first exposure level;
reregistering the third frame with respect to the second frame based at least in part upon motion estimation, where the motion estimation accounts for the different exposure levels; and
combining the second frame with the reregistered third frame to generate a second HDR frame.

5. The method of claim 4, wherein the second HDR frame is adjacent to the first HDR frame in a series of HDR video frames.

6. The method of claim 4, wherein the second and third frames are adjacent frames in the series of digital video frames.

7. The method of claim 1, further comprising:
obtaining a third frame from the series of digital video frames, the third frame having the first exposure level;
obtaining a fourth frame from the series of digital video frames, the fourth frame having the second exposure level;
reregistering the fourth frame with respect to the third frame based at least in part upon motion estimation, where the motion estimation accounts for the different exposure levels; and
combining the third frame with the reregistered fourth frame to generate a second HDR frame.

8. The method of claim 7, wherein the second HDR frame is adjacent to the first HDR frame in a series of HDR video frames.

9. The method of claim 8, wherein the third and fourth frames are adjacent frames in the series of digital video frames.

10. The method of claim 9, wherein the second and third frames are adjacent frames in the series of digital video frames.

11. The method of claim 1, further comprising:
obtaining a third frame from the series of digital video frames, the third frame having the third exposure level different than the first and second exposure levels;
reregistering the third frame with respect to the first frame based at least in part upon motion estimation, where the motion estimation accounts for the different exposure levels; and
combining the first frame with the reregistered second frame and the reregistered third frame to generate the HDR frame.

12. The method of claim 11, wherein the first and third frames are adjacent frames in the series of digital video frames.

13. The method of claim 12, further comprising:
obtaining a fourth frame from the series of digital video frames, the third frame having the second exposure level;
reregistering the first and fourth frames with respect to the third frame based at least in part upon motion estimation, where the motion estimation accounts for the different exposure levels; and
combining the third frame with the reregistered first frame and the reregistered fourth frame to generate a second HDR frame adjacent to the first HDR frame in a series of HDR video frames.

14. The method of claim 1, further comprising controlling an optical attenuator to provide the first and second exposure levels.

15. A video device, comprising:
means for attenuating the exposure of a video frame captured by an image capture device; and
a high dynamic range (HDR) converter configured to combine a plurality of digital video frames to generate an HDR frame, where each digital video frame combined to generate the HDR frame has a different exposure level.

16. The video device of claim 15, wherein the means for attenuating the exposure includes an optical attenuator.

17. The video device of claim 16, wherein the optical attenuator is a liquid crystal light attenuation panel.

18. The video device of claim 15, wherein the means for attenuating the exposure comprises adjusting an aperture to vary the exposure level.

19. The video device of claim 15, wherein combining the plurality of digital video frames to generate the HDR frame includes:
reregistering a first frame of the plurality of digital video frames with respect to a second frame of the plurality of digital video frames based at least in part upon motion estimation, where the motion estimation accounts for the different exposure levels; and
combining the second frame with the reregistered first frame to generate the HDR frame.

20. The video device of claim 19, wherein combining the plurality of digital video frames to generate the HDR frame further includes:
reregistering a third frame of the plurality of digital video frames with respect to the second frame based at least in part upon motion estimation, where the motion estimation accounts for the different exposure levels; and
combining the second frame with the reregistered first frame and the reregistered third frame to generate the HDR frame.
